(19) United States
(12) Patent Application Publication
(10) Pub. No.: US 2015/0008819 A1
(43) Pub. Date: Jan. 8, 2015

(54) OLED Panel and Package Method Thereof

(71) Applicant: Shenzhen China Star Optoelectronics Technology Co., Ltd., Shenzhen (CN)

(72) Inventor: Wei Yu, Shenzhen (CN)

(21) Appl. No.: 13/982,510

(22) PCT Filed: Jul. 8, 2013
(86) PCT No.: PCT/CN2013/079023

§ 371 Date: Jul. 30, 2013

(30) Foreign Application Priority Data
Jul. 5, 2013 (CN) 201310282099.4

(51) Int. Cl. H05B 33/04; H05B 33/10

(52) U.S. Cl. CPC H05B 33/04; H05B 33/10
USPC 313/504; 445/25

(57) ABSTRACT

The present invention provides an OLED panel and the package method thereof. The OLED panel comprises: a substrate 40, multiple OLED devices 42 formed on the substrate 40, a package cover 20 attached oppositely to the substrate 40 and multiple sealed plastic frame 60 provided between the substrate 40 and the package cover 20 and corresponding to the OLED device 42. The package cover 20 is provided with multiple protrusions 42 corresponding to the multiple OLED devices 22. A groove 24 is formed around the protrusion 22. The sealed plastic frame 60 is located in the groove 24. The lower surface of the protrusion 22 is close to the upper surface of the OLED device 42.

### BACKGROUND OF THE INVENTION

1. Field of the Invention

The present invention relates to the field of flat panel display techniques, and in particular to an OLED panel and the package method thereof.

2. The Related Arts

Flat display device has many advantages of thin body, low power, no radiation, etc., so it has been widely applied. The flat display device according to the prior art mainly comprises liquid crystal display (LCD) and organic light emitting display (OLED).

The organic light emitting display device has characteristics of self-luminous, high brightness, wide viewing angle, high contrast, flexible, low power consumption, etc. So, it has been widely concerned and is a new generation of display, which has begun to gradually replace the traditional liquid crystal display device and is widely used in mobile phone screen, computer monitor, full-color television and other electronic products. OLED display technology differs from traditional LCD display, which doesn't need backlight and utilizes very thin organic material coating and glass substrate. When a current is passed, the organic materials will luminesce. However, the organic materials are sensitive to water vapor and oxygen, which is susceptible to degeneration and aging due to water and oxygen, so that the brightness and life time will significantly decay. Therefore, as a display device based on organic materials, the demands of the package of the OLED device are very heavy. In order to achieve commercial applications, the lifetime of OLED device is required to be greater than or equal to 10,000 hours; water vapor transmission rate is less than or equal to 10⁻⁶g/m²/day; oxygen transmission rate is less than or equal to 10⁻⁵cc/m²/day. Therefore, the package of OLED device is the most important process during the production, which is the key to affect the product yield.

The existing package is generally to coat a sealed plastic frame at the package cover of flat OLED, then to attach the OLED substrate to the same, and to cure the sealed plastic frame to finish the package. An enclosed space is formed within the OLED package cover, the OLED substrate and the sealed plastic frame. The organic luminescent material layer is sealed in the enclosed space. However, the OLED panel formed in this way has a certain gap between the OLED package cover and the OLED substrate. The gap width is micron-scale, while the thickness of the organic luminescent material layer is nano-scale. The existence of the gap increases the existing possibility of residual water and oxygen, which affects the lifetime of the OLED panel.

Referring to FIG. 1, it is a partial cross-sectional view of the OLED panel according to the prior art. The OLED panel comprises a first glass substrate 100, an etching groove 200, a frit 300, a second glass substrate 400, at least one OLED device 500 and at least one electrode 600 contacting with the OLED device 500. The frit 300 is located between the first and the second glass substrates 100, 400 and located within the outer edge of the OLED device, which forms an airtight sealing body protecting the inner OLED device 500. Due to the presence of the etching groove 200, it enhances the strength of the frit bonding the first and second glass substrates 100, 400, which improves the sealing effects. However, the OLED panel obtained by the sealing method still has larger gap between the first and second glass substrates 100, 400, which increases the possibility of residual water and oxygen existing in the sealing body and affects the lifetime of the OLED panel.

### SUMMARY OF THE INVENTION

The object of the present invention is to provide an OLED panel, which has simple structure, smaller sealing space, less residual water and oxygen, and longer lifetime.

The another object of the present invention is to provide a package method of the OLED panel, by which the sealing effect is good, the residual water and oxygen in the sealing space is less, and the lifetime of the OLED panel is effectively extended.

In order to achieve the above objective, the present invention provides an OLED panel, comprising: a substrate, multiple OLED devices formed on the substrate, a package cover attached oppositely to the substrate and multiple sealed plastic frame provided between the substrate and the package cover and corresponding to the OLED device, the package cover being provided with multiple protrusions corresponding to the multiple OLED devices, a groove being formed around the protrusion, the sealed plastic frame being located in the groove, the lower surface of the protrusion being close to the upper surface of the OLED device.

The package cover is made of glass, and the groove is formed through etching process.

The etching process is acid etching process or dry etching process.

The substrate is glass substrate; the OLED device comprises: an anode formed on the substrate, an organic material layer formed on the anode and a cathode formed on the organic material layer.

The present invention further provides a package method of the OLED panel, comprising the following steps:

step 1, providing a package cover, the package cover being provided with multiple protrusions, a groove being formed around the protrusion;
step 2, cleaning and drying the package cover;
step 3, coating an UV glue in the groove of the package cover corresponding to the outer periphery of the multiple protrusions, the thickness of the UV glue being larger than the height of the protrusion;
step 4, providing a substrate with an OLED device, the OLED device being provided corresponding to the protrusion of the package cover; and
step 5, attaching the package cover opposite to the substrate under nitrogen atmosphere, the protrusion of the package cover being toward the substrate, using ultraviolet radiation curing the UV glue to form a sealed plastic frame and finishing the package of the OLED panel.

The package cover is made of glass substrate, the groove is formed through etching process, and the etching process is acid etching process or dry etching process.

The OLED device comprises: an anode formed on the substrate, an organic material layer formed on the anode and a cathode formed on the organic material layer.

The present invention further provides a package method of the OLED panel, comprising the following steps:

step 101, providing a package cover, the package cover being provided with multiple protrusions, a groove being formed around the protrusion;
step 102, cleaning and drying the package cover;
step 103, coating a glass glue in the groove of the package cover corresponding to the outer periphery of the multiple protrusions, the thickness of the glass glue being larger than the height of the protrusion, curing the glass glue in a high temperature furnace;
step 104, coating an UV glue at the outer edge of the package cover;
step 105, providing a substrate with an OLED device, the OLED device being provided corresponding to the protrusion of the package cover;
step 106, attaching the package cover opposite to the substrate under nitrogen atmosphere, the protrusion of the package cover being toward the substrate, using ultraviolet radiation curing the UV glue; and
step 107, using laser irradiation, melting the glass glue and attaching the package cover to the substrate, then curing to form a sealed plastic frame and finishing the package of the OLED panel.

The package cover is made of glass substrate, the groove is formed through etching process, and the etching process is acid etching process or dry etching process.

The OLED device comprises: an anode formed on the substrate, an organic material layer formed on the anode and a cathode formed on the organic material layer.

The present invention has the following beneficial effects.

In the OLED panel and the package method thereof according to the present invention, etch the grooves on the package cover, and form the multiple protrusions correspondingly. When packing, there is almost no gap between the lower surface of the protrusion of the package cover and the upper surface of the OLED device formed on the substrate, which effectively reduces the enclosed space, significantly decreases the existing possibility of the residual water and oxygen during package, extends the lifetime of OLED device, and then extends the lifetime of OLED panel.

In order to more clearly describe the embodiments in the present invention or the technical solutions in the prior art, the detailed descriptions of the present invention and the accompanying drawings are as follows. However, the drawings and descriptions are only used as reference, which is not intended to limit the present invention.

### BRIEF DESCRIPTION OF THE DRAWINGS

The detailed descriptions accompanying drawings and the embodiment of the present invention are as follows, which allows the technical solutions and other beneficial effects of the present invention more obvious.

FIG. 1 is a partial cross-sectional view of the OLED panel according to the prior art;

FIG. 2 is a schematic structural diagram of the OLED panel according to the present invention;

FIG. 3 is a schematic planar structural diagram of the package cover in the OLED panel according to the present invention;

FIG. 4 is a schematic perspective view of the package cover in the OLED panel according to the present invention;

FIG. 5 is a schematic position relationship of the package cover and the sealed plastic frame in the OLED panel according to the present invention;

FIG. 6 is a flow chart of the package method of the OLED panel according to an embodiment of the present invention; and

FIG. 7 is a flow chart of the package method of the OLED panel according to another embodiment of the present invention.

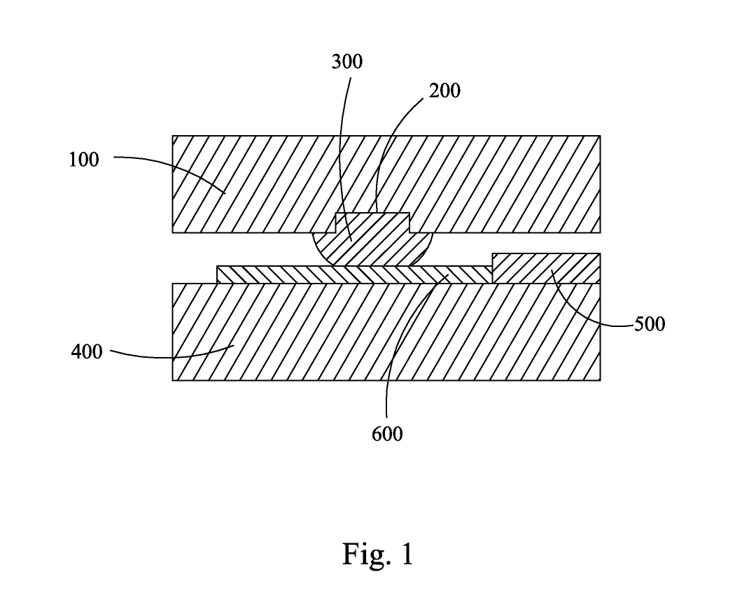

### DETAILED DESCRIPTION OF THE PREFERRED EMBODIMENTS

In order to more clearly describe the technical solutions and the effects in the present invention, the preferred embodiment of the present invention accompanying drawings are described in detail as follows.

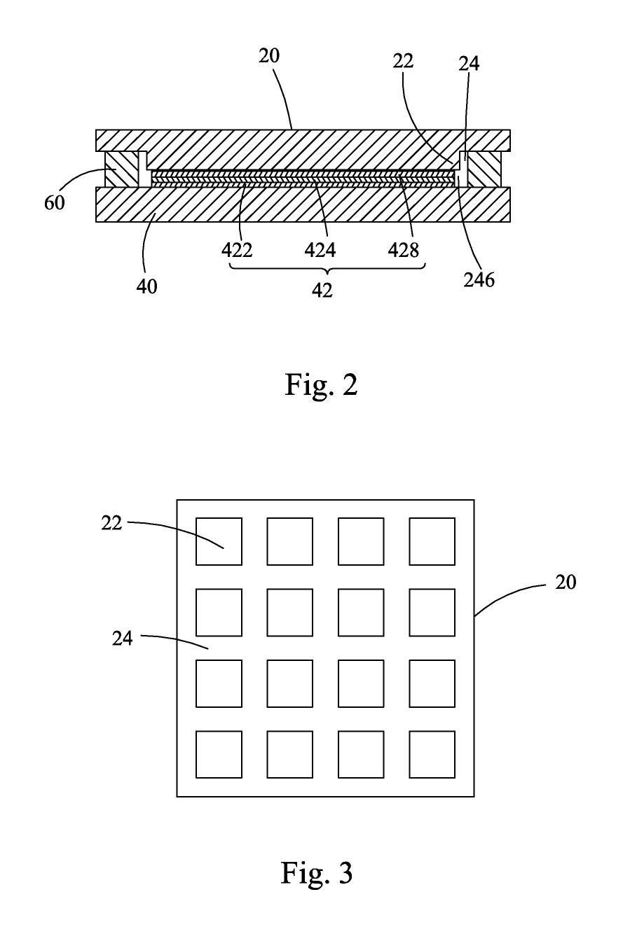

Referring to FIGS. 2 and 5, the present invention provides an OLED panel, comprising: a substrate 40, multiple OLED devices 42 formed on the substrate 40, a package cover 20 attached oppositely to the substrate 40 and multiple sealed plastic frame 60 provided between the substrate 40 and the package cover 20 and corresponding to the OLED device 42. The package cover 20 is provided with multiple protrusions 22 corresponding to the multiple OLED devices 42. A groove 24 is formed around the protrusion 22. The sealed plastic frame 60 is located in the groove 24. The lower surface of the protrusion 22 is close to the upper surface of the OLED device 42, so that a sealing space 246 formed within the package cover 20, the substrate 40 and the sealed plastic frame 60 is smaller. The OLED devices 42 almost fill the entire sealing space 246, so that the residual water vapor in the sealing space 246 is less, which reduces the oxidation corrosion OLED device 42 due to the water vapor, extends the lifetime of the OLED device 42, and then extends the lifetime of the OLED panel.

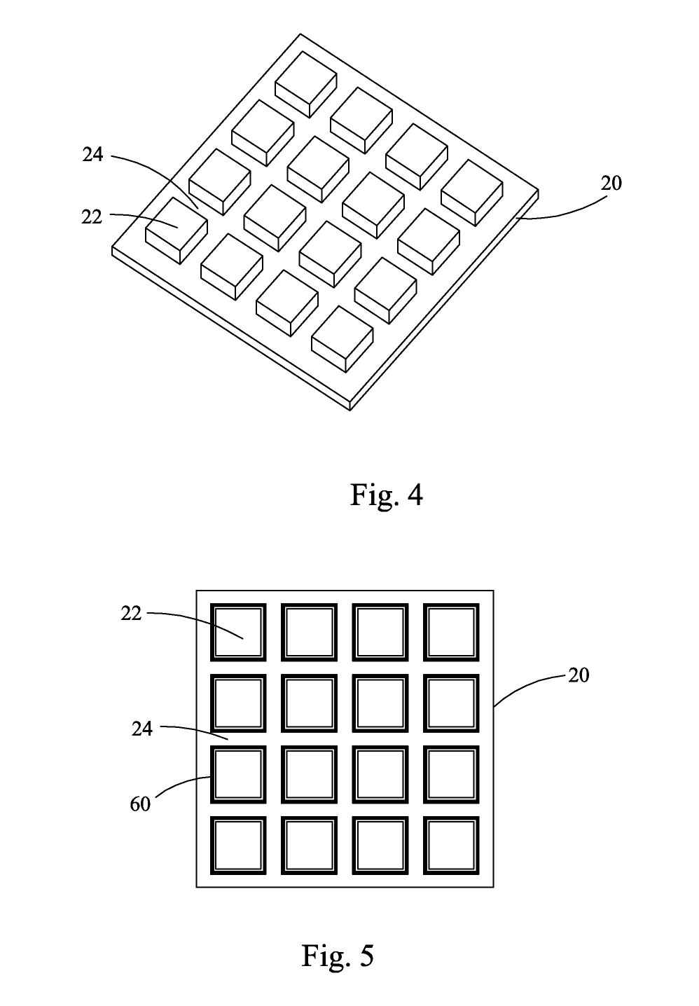

Referring to FIGS. 3 and 4, the package cover 20 is made of glass, the groove 24 is formed through etching process, and the etching process is acid etching process or dry etching process. The specific formation process is as follows:

first, providing a cleaned and dried glass substrate; coating photoresist on the glass substrate; exposing the glass substrate coated with photoresist under a designed mask; developing the exposed glass substrate in a developer to remove the exposed photoresist; baking in a backing machine, the photoresist remaining on the glass substrate forming multiple etching protection blocks, the etching protection blocks being rectangular, an etching region being formed at the outer edge of the multiple etching protection blocks on the glass substrate, the etching region being several etching grooves intersecting each other; etching the glass substrate through acid etching process or dry etching process and forming the semi-manufactured package cover; finally, lifting off the residual photoresist and forming the package cover 20.

Referring to FIG. 2, it is noted that the substrate 40 is glass substrate; the OLED device 42 comprises: an anode 422 formed on the substrate 40, an organic material layer 424 formed on the anode 422 and a cathode 428 formed on the organic material layer 424.

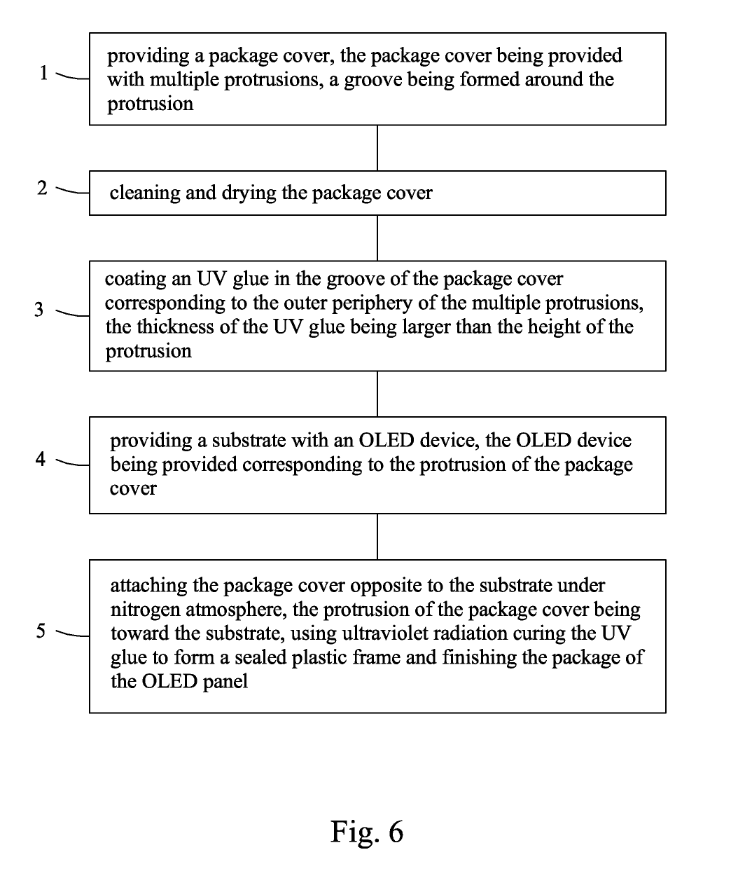

Referring to FIG. 6, and referring to FIGS. 2 to 5, the present invention further provides a package method of the OLED panel, comprising the following steps:

Step 1, providing a package cover 20, the package cover 20 being provided with multiple protrusions 22, a groove 24 being formed around the protrusion 22.

The package cover 20 is made of glass, the groove 24 is formed through etching process, and the etching process is acid etching process or dry etching process. The specific formation process is as follows:

first, providing a cleaned and dried glass substrate; coating photoresist on the glass substrate; exposing the glass substrate coated with photoresist under a designed mask; developing the exposed glass substrate in a developer to remove the exposed photoresist; baking in a backing machine, the photoresist remaining on the glass substrate forming multiple etching protection blocks, the etching protection blocks being rectangular, an etching region being formed at the outer edge of the multiple etching protection blocks on the glass substrate, the etching region being several etching grooves intersecting each other; etching the glass substrate through acid etching process or dry etching process and forming the semi-manufactured package cover; finally, lifting off the residual photoresist and forming the package cover 20.

Step 2, cleaning and drying the package cover 20.

Step 3, coating an UV glue in the groove 24 of the package cover 20 corresponding to the outer periphery of the multiple protrusions 22, the thickness of the UV glue being larger than the height of the protrusion 22.

Step 4, providing a substrate 40 with an OLED device 42, the OLED device 42 being provided corresponding to the protrusion 22 of the package cover 20.

The substrate 40 is glass substrate; the OLED device 42 comprises: an anode 422 formed on the substrate 40, an organic material layer 424 formed on the anode 422 and a cathode 428 formed on the organic material layer 424.

Step 5, attaching the package cover 20 opposite to the substrate 40 under nitrogen atmosphere, the protrusion 22 of the package cover 20 being toward the substrate 40, and using ultraviolet radiation curing the UV glue to form a sealed plastic frame 60 and finishing the package of the OLED panel.

A sealing space 246 is formed within the package cover 20, the substrate 40 and the sealed plastic frame 60. The OLED device 42 is sealed in the sealing space 246. The lower surface of the protrusion 22 of the OLED package cover 20 almost contacts with the upper surface of the OLED device 42. There is almost no gap between the package cover 20 and the substrate 40. The sealing space 246 significantly decreases the existing possibility of the residual water and oxygen and then extends the lifetime of OLED device 42. The OLED devices 42 according to the present invention almost fill the entire sealing space 246, so that the residual water vapor in the sealing space 246 is less, which reduces the oxidation corrosion OLED device 42 due to the water vapor, extends the lifetime of the OLED device 42, and then extends the lifetime of the OLED panel.

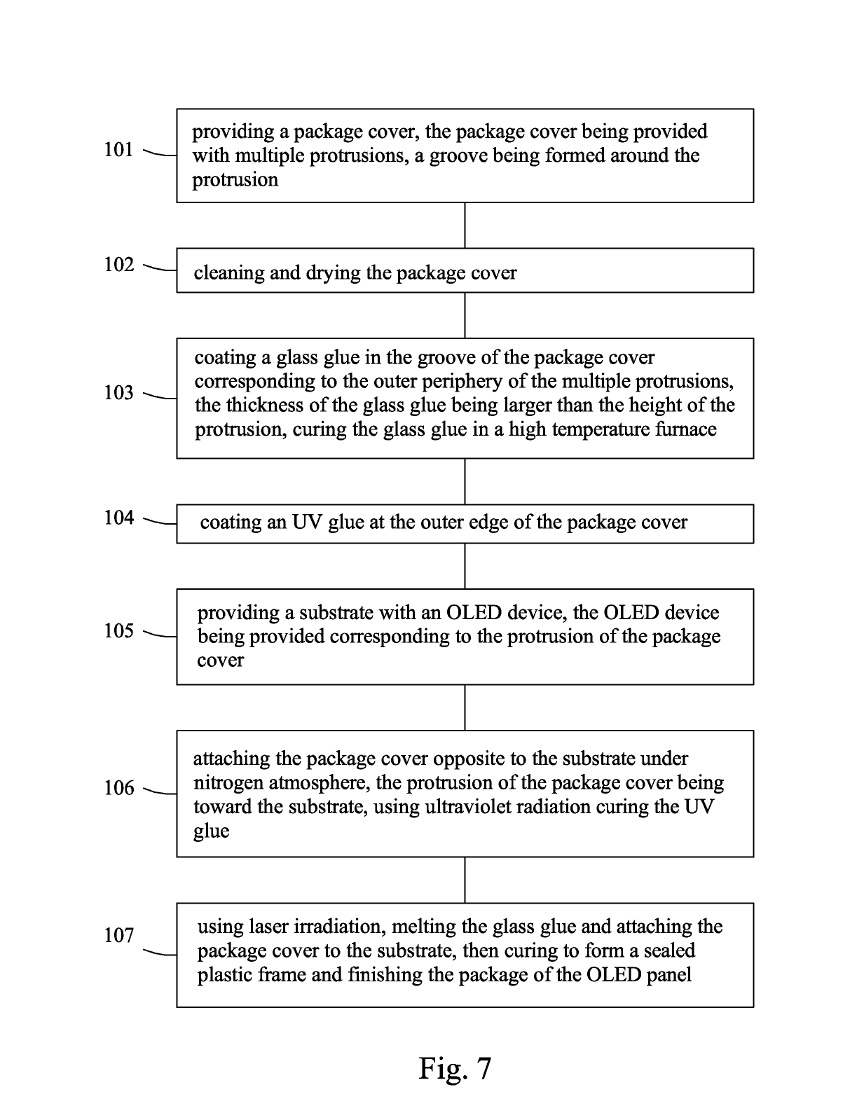

Referring to FIG. 7, and referring to FIGS. 2 to 5, the present invention further provides a package method of the OLED panel, comprising the following steps:

Step 101, providing a package cover 20, the package cover 20 being provided with multiple protrusions 22, and a groove 24 being formed around the protrusion 22.

The package cover 20 is made of glass, the groove 24 is formed through etching process, and the etching process is acid etching process or dry etching process. The specific formation process is as follows:

first, providing a cleaned and dried glass substrate; coating photoresist on the glass substrate; exposing the glass substrate coated with photoresist under a designed mask; developing the exposed glass substrate in a developer to remove the exposed photoresist; baking in a backing machine, the photoresist remaining on the glass substrate forming multiple etching protection blocks, the etching protection blocks being rectangular, an etching region being formed at the outer edge of the multiple etching protection blocks on the glass substrate, the etching region being several etching grooves intersecting each other; etching the glass substrate through acid etching process or dry etching process and forming the semi-manufactured package cover; finally, lifting off the residual photoresist and forming the package cover 20.

Step 102, cleaning and drying the package cover 20.

Step 103, coating a glass glue in the groove 24 of the package cover 20 corresponding to the outer periphery of the multiple protrusions 22, the thickness of the glass glue being larger than the height of the protrusion 22, curing the glass glue in a high temperature furnace.

Step 104, coating an UV glue at the outer edge of the package cover 20.

Step 105, providing a substrate 40 with an OLED device 42, the OLED device 42 being provided corresponding to the protrusion 22 of the package cover 20.

The substrate 40 is glass substrate; the OLED device 42 comprises: an anode 422 formed on the substrate 40, an organic material layer 424 formed on the anode 422 and a cathode 428 formed on the organic material layer 424.

Step 106, attaching the package cover 20 opposite to the substrate 40 under nitrogen atmosphere, the protrusion 22 of the package cover 20 being toward the OLED substrate 40, and using ultraviolet radiation curing the UV glue.

Attach the package cover 20 opposite to the substrate 40 under nitrogen atmosphere. The protrusion 22 of the package cover 20 is toward the OLED substrate 40. Use ultraviolet radiation curing the UV glue, and then temporarily fix the package cover 20 and the substrate 40 and isolate the water vapor.

Step 107, using laser irradiation, melting the glass glue and attaching the package cover 20 to the substrate 40, then curing to form a sealed plastic frame 60 and finishing the package of the OLED panel.

A sealing space 246 is formed within the package cover 20, the substrate 40 and the sealed plastic frame 60. The OLED device 42 is sealed in the sealing space 246. The lower surface of the protrusion 22 of the OLED package cover 20 almost contacts with the upper surface of the OLED device 42. There is almost no gap between the package cover 20 and the substrate 40. The sealing space 246 significantly decreases the existing possibility of the residual water and oxygen and then extends the lifetime of OLED device 42. The OLED devices 42 according to the present invention almost fill the entire sealing space 246, so that the residual water vapor in the sealing space 246 is less, which reduces the oxidation corrosion OLED device 42 due to the water vapor, extends the lifetime of the OLED device 42, and then extends the lifetime of the OLED panel.

In summary, in the OLED panel and the package method thereof according to the present invention, etch the grooves on the package cover, and form the multiple protrusions correspondingly. When packing, there is almost no gap between the lower surface of the protrusion of the package cover and the upper surface of the OLED device formed on the substrate, which effectively reduces the enclosed space, significantly decreases the existing possibility of the residual water and oxygen during package, extends the lifetime of OLED device, and then extends the lifetime of OLED panel.

For those having ordinary skills in the art, the technical idea and the technical solution can be changed and modified according to the present invention. Any deduction or modification according to the present invention is considered encompassed in the scope of protection defined by the clams of the present invention.

What is claimed is:

1. An OLED panel, comprising: a substrate, multiple OLED devices formed on the substrate, a package cover attached oppositely to the substrate and multiple sealed plastic frame provided between the substrate and the package cover and corresponding to the OLED device, the package cover being provided with multiple protrusions corresponding to the multiple OLED devices, a groove being formed around the protrusion, the sealed plastic frame being located in the groove, the lower surface of the protrusion being close to the upper surface of the OLED device.

2. The OLED panel as claimed in claim 1, wherein the package cover is made of glass, and the groove is formed through etching process.

3. The OLED panel as claimed in claim 2, wherein the etching process is acid etching process or dry etching process.

4. The OLED panel as claimed in claim 1, wherein the substrate is glass substrate; the OLED device comprises: an anode formed on the substrate, an organic material layer formed on the anode and a cathode formed on the organic material layer.

5. A package method of the OLED panel, comprising the following steps:
step 1, providing a package cover, the package cover being provided with multiple protrusions, a groove being formed around the protrusion;
step 2, cleaning and drying the package cover;
step 3, coating an UV glue in the groove of the package cover corresponding to the outer periphery of the multiple protrusions, the thickness of the UV glue being larger than the height of the protrusion;
step 4, providing a substrate with an OLED device, the OLED device being provided corresponding to the protrusion of the package cover; and
step 5, attaching the package cover opposite to the substrate under nitrogen atmosphere, the protrusion of the package cover being toward the substrate, using ultraviolet radiation curing the UV glue to form a sealed plastic frame and finishing the package of the OLED panel.

6. The package method of the OLED panel as claimed in claim 5, wherein the package cover is made of glass substrate, the groove is formed through etching process, and the etching process is acid etching process or dry etching process.

7. The package method of the OLED panel as claimed in claim 5, wherein the OLED device comprises: an anode formed on the substrate, an organic material layer formed on the anode and a cathode formed on the organic material layer.

8. A package method of the OLED panel, comprising the following steps:
step 101, providing a package cover, the package cover being provided with multiple protrusions, a groove being formed around the protrusion;
step 102, cleaning and drying the package cover;
step 103, coating a glass glue in the groove of the package cover corresponding to the outer periphery of the multiple protrusions, the thickness of the glass glue being larger than the height of the protrusion, curing the glass glue in a high temperature furnace;
step 104, coating an UV glue at the outer edge of the package cover;
step 105, providing a substrate with an OLED device, the OLED device being provided corresponding to the protrusion of the package cover;
step 106, attaching the package cover opposite to the substrate under nitrogen atmosphere, the protrusion of the package cover being toward the substrate, using ultraviolet radiation curing the UV glue; and
step 107, using laser irradiation, melting the glass glue and attaching the package cover to the substrate, then curing to form a sealed plastic frame and finishing the package of the OLED panel.

9. The package method of the OLED panel as claimed in claim 8, wherein the package cover is made of glass substrate, the groove is formed through etching process, and the etching process is acid etching process or dry etching process.

10. The package method of the OLED panel as claimed in claim 8, wherein the OLED device comprises: an anode formed on the substrate, an organic material layer formed on the anode and a cathode formed on the organic material layer.
